(19) United States
(12) Patent Application Publication
(10) Pub. No.: US 2025/0291137 A1
(43) Pub. Date: Sep. 18, 2025

(54) SILICON PHOTONIC CHIP PACKAGE MODULE BASED ON PLASTIC ENCAPSULATION

(71) Applicant: OIP Technology Pte Ltd, Singapore (SG)

(72) Inventor: Yonggang JIN, Singapore (SG)

(21) Appl. No.: 18/606,469

(22) Filed: Mar. 15, 2024

(51) Int. Cl. G02B 6/42

(52) U.S. Cl. CPC G02B 6/4253

(57) ABSTRACT

The present invention provides a photonic chip package module based on plastic encapsulation, which includes: a silicon photonic chip having a top surface, a bottom surface and side surfaces and incorporating an optical signal processing element, a port connected to the optical signal processing element is provided on one of the side surfaces; a transparent cushioning material layer provided on said side surface of the silicon photonic chip so as to cover the port; and a plastic encapsulation layer, which at least surrounds the silicon photonic chip at its side surfaces and at least circumferentially encapsulates the silicon photonic chip, a groove for receiving a fiber optic therein is provided in the plastic encapsulation layer, which extends towards the port and terminates at one end within the transparent cushioning material layer, thereby allowing the port to be optically connected to the fiber optic and to receive an optical signal.

### TECHNICAL FIELD

The present invention relates to the field of optics and, in particular, to an optical device and a method for packaging thereof.

### BACKGROUND

As information technology and semiconductor technology are continuously advancing, electronic devices such as mobile phones, personal digital assistants (PADs) and smart watches are increasingly evolving towards a lighter weight and higher functional integration. This places increasingly stringent requirements on chip integration, creating unprecedented challenges to chip packaging. Increasing mismatches of interconnection pitches, addition of various chips with different functions and package shrinkage without compromising an available chip area for an extended battery life have created a ground for innovations in embedded packaging technology.

Conventional optical devices are usually packaged using a chip-on-board (COB) packaging technique, in which optical structures, such as a silicon photonic chip and an optical converter chip, are attached to an interconnection substrate (typically, a printed circuit board (PCB)) with a conductive or non-conductive adhesive. Some of the intended electrical connections are then made by wire bonding, and the silicon photonic optical converter chips are electrically connected to each other and to external circuits with metal wires. Moreover, after a fiber optic is optically connected to the PCB, the silicon photonic chip is optically connected to the optical converter chip with an optically conductive material. However, in such a direct packaging approach, electrical connections tend to be made with long metal wires having considerable resistance, which convert a significant fraction of electricity that they conduct into useless thermal energy, creating a risk of burning of the PCB. Sometimes, it may be necessary to add a heat sink for heat dissipation, leading to an increase in material cost. Further, since the optically conductive material is typically a transparent organic material, and because the fiber optic is usually made of glass, as a result of a signal propagating into the optically conductive material from the fiber optic, noise may be introduced into the signal from the fiber optic, the silicon photonic chip and the optical converter chip due to a signal mismatch. Furthermore, the silicon photonic and optical converter chips are spaced from each other and from other components at a distance of about 500 μm, making further shrinkage of the optical device impossible and thus possibly making it less competitive.

Chinese Pat. App. Pub. No. CN110488434B discloses a package structure for an optical device, which allows the optical device to be directly optically connected to a fiber optic. This can simplify the structure of the optical device and reduce its material cost. However, during the formation of a groove for receiving the fiber optic by means of laser etching, it is very likely for a silicon photonic chip in the optical device to be damaged. In addition, the establishment of the connection between the fiber optic and the optical device is associated with high requirements for alignment accuracy.

### SUMMARY OF THE INVENTION

It is an objective of the present invention to provide an improved silicon photonic chip package module, which, in addition to the advantages of existing silicon photonic chip package modules, has the capabilities of avoiding chip damage due to laser engraving and compensating for an alignment error between a fiber optic and an optical device, lowering requirements for alignment accuracy.

To this end, in a first aspect, there is provided a silicon photonic chip package module including:
a silicon photonic chip having a top surface, a bottom surface and side surfaces and incorporating an optical signal processing element, wherein a port connected to the optical signal processing element is provided on one of the side surfaces;
a transparent cushioning material layer provided on said side surface of the silicon photonic chip so as to cover the port; and
a plastic encapsulation layer, which at least surrounds the silicon photonic chip at its side surfaces and thus at least circumferentially encapsulates the silicon photonic chip,
wherein a groove for receiving a fiber optic therein is provided in the plastic encapsulation layer, which extends towards the port and terminates at one end within the transparent cushioning material layer, thereby allowing the port to be optically connected to the fiber optic through the transparent cushioning material layer and to receive an optical signal.

In a second aspect, there is provided a silicon photonic chip package module including:
a plurality of mutually spaced silicon photonic chips, each having a top surface, a bottom surface and side surfaces and incorporating an optical signal processing element, wherein a port connected to the optical signal processing element is provided on one of the side surfaces;
transparent cushioning material layers, which are provided on said side surfaces of the respective silicon photonic chip so as to cover the respective ports; and
a plastic encapsulation layer, which is filled in gaps around each silicon photonic chip to electrically isolate these silicon photonic chips,
wherein grooves for receiving fiber optics therein are provided in the plastic encapsulation layer, each of which extends towards the port of a respective one of the silicon photonic chips and terminates at one end within a respective one of the transparent cushioning material layers, thereby allowing the ports of the respective silicon photonic chips to be optically connected to the respective fiber optics through the respective transparent cushioning material layers and to receive optical signals.

Compared with the prior art, the present invention has the benefits as follows:

The silicon photonic chip package module is allowed to be directly optically connected to a fiber optic. In addition to simplifying the structure of the resulting optical device and reducing its material cost, this solves the problem of noise resulting from a mismatch between an optically conductive material and the fiber optic.

The transparent cushioning material layer can effectively protect the silicon photonic chip from possible damage during laser engraving. Moreover, the transparent cushioning material layer can be configured as an optical element in the form of a frustum of a cone, which allows a spot diameter of an optical signal from the fiber optic to be expanded during its propagation through the transparent cushioning material layer. As a result, even when there is an alignment error between the end of the fiber optic and the light-receiving port of the silicon photonic chip, optical signals can be received, achieving alignment error compensation.

Further, the silicon photonic chip package module includes a metal interconnect layer that is electrically connected to the solder pads on the silicon photonic chip instead of conventional metal wires. This enables spatial integration, less loss of electrical energy and higher utilization of electrical energy. Additionally, it reduces the risk of circuit damage resulting from heat dissipation and dispenses with the need of adding a heat sink, resulting in reduced material cost.

### BRIEF DESCRIPTION OF THE DRAWINGS

FIG. 1 is a schematic top view of a silicon photonic chip package module according to an embodiment of the present invention.

FIG. 2 is a schematic cross-sectional view taken along AA′ of FIG. 1.

FIG. 3A is a schematic cross-sectional view taken along BB′ of FIG. 1 according to an embodiment of the present invention.

FIG. 3B is a schematic cross-sectional view taken along BB′ of FIG. 1 according to another embodiment of the present invention.

FIG. 4 is a schematic cross-sectional view of an optical device according to an embodiment of the present invention.

FIG. 5 is a schematic top view of a silicon photonic chip package module according to an embodiment of the present invention.

### DETAILED DESCRIPTION

In principle, the present invention seeks to provide a silicon photonic chip package module, which can be optically connected to a fiber optic to simply the structure of an optical device and reduce its material cost. Moreover, it solves the problem of noise resulting from a mismatch between an optically conductive material and the fiber optic.

The present invention will be described in greater detail below with reference to the accompanying drawings, which illustrate specific embodiments of the invention. Note that the figures are presented in a very simplified form not necessarily drawn to exact scale and for the only purpose of facilitating easy and clear description of the embodiments disclosed herein.

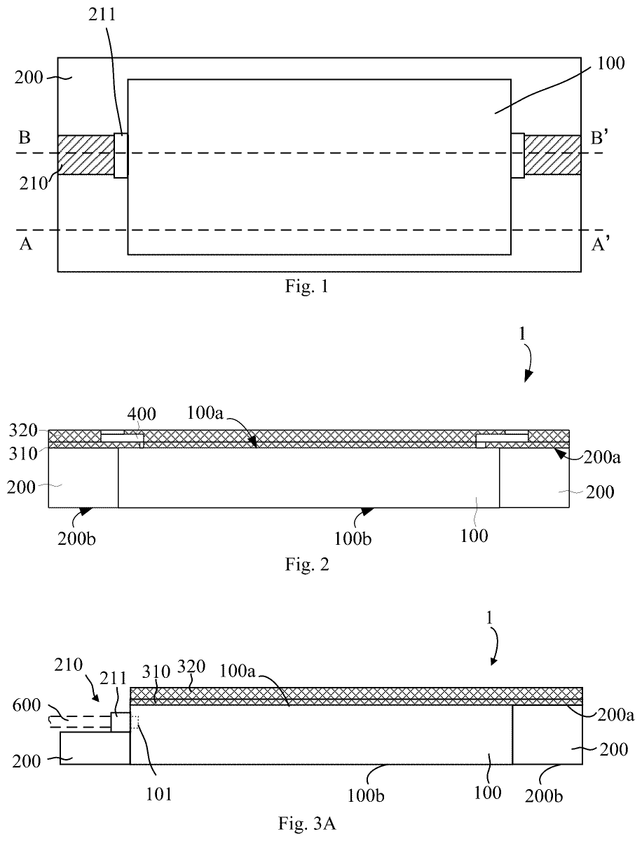

As shown in FIGS. 1 to 5, an optical device according to an embodiment of the present invention is configured to be optically connected to a fiber optic. The optical device includes a silicon photonic chip package module 1 and a substrate 2. The silicon photonic chip package module 1 is electrically connected to the substrate 2 (see FIG. 4), and the fiber optic 600 is directly optically connected to the silicon photonic chip package module 1.

The silicon photonic chip package module 1 may include at least one silicon photonic chip 100. When a single silicon photonic chip 100 is included, the silicon photonic chip 100 may be, for example, a photonic or light-emitting chip. In case of two or more silicon photonic chips 100 being included, the silicon photonic chips 100 may include at least one photonic chip and/or at least one light-emitting chip. In other words, all the silicon photonic chips 100 may be photonic or light-emitting chips, or the silicon photonic chips 100 may include both photonic and light-emitting chips, for example. As many photonic chips as desired may be used. Likewise, as many light-emitting chips as desired may be used. When there are two or more silicon photonic chips 100, the silicon photonic chips 100 may be spaced apart at a distance greater than or equal to 50 μm between adjacent silicon photonic chips 100. Such a distance not only allows adjacent silicon photonic chips 100 to be minimally influenced by heat generated from conduction of electricity between them, but also avoids signal interference between adjacent silicon photonic chips 100. Compared with conventional packaging methods in which adjacent silicon photonic chips 100 are spaced at a distance greater than or equal to 500 μm, the present invention allows adjacent silicon photonic chips 100 to be spaced at a distance less than 100 μm, resulting in space savings. This allows additional shrinkage of the optical device, which makes it more competitive.

In this embodiment, for example, the silicon photonic chip package module 1 includes a single silicon photonic chip 100. For example, the silicon photonic chip 100 has a top surface 100a, a bottom surface 100b opposite to the top surface, and side surfaces connecting the top 100a and bottom 100b surfaces. Solder pads (not shown) configured to be electrically connected to external circuits are provided on the top surface 100a. A port 101 is provided in one of the side surfaces and proximate the top surface 100a of the silicon photonic chip 100. One end of the port 101 is connected to an optical signal processing element built in the silicon photonic chip, and the other end is configured to receive an optical signal from the fiber optic 600.

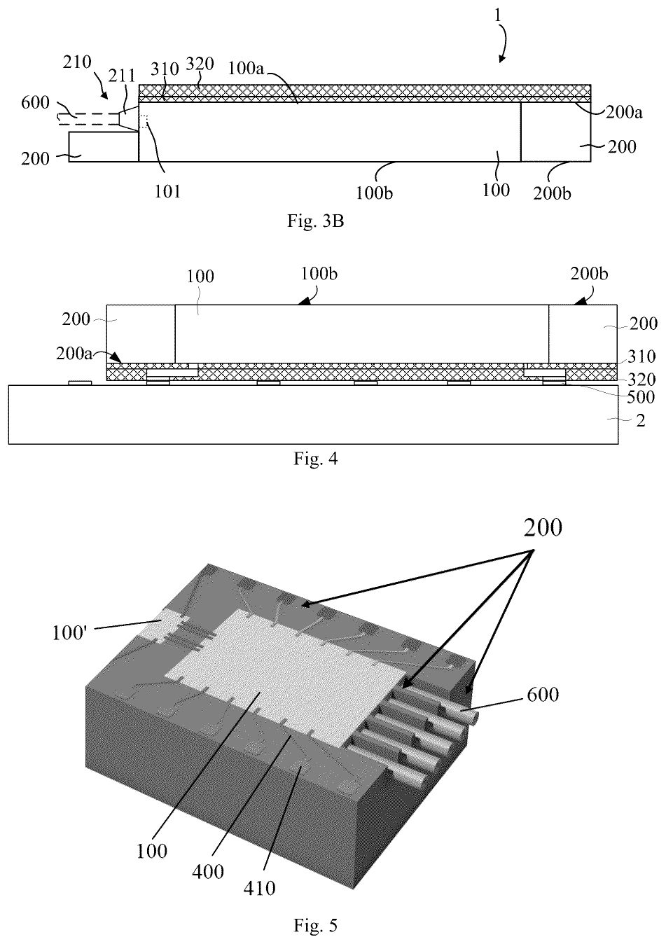

As shown in FIGS. 3A and 3B, the silicon photonic chip package module 1 includes a transparent cushioning material layer 211, which is provided on said side surface of the silicon photonic chip 100 so as to cover the port 101. The port 101 is connected to the fiber optic 600 via the transparent cushioning material layer 211. The transparent cushioning material layer 211 has a light transmittance of 95% or higher, which can minimize energy loss of an optical signal during its propagation through the transparent cushioning material layer. The transparent cushioning material layer 211 may have a thickness of 50-100 μm measured in the direction of propagation of the optical signal. The transparent cushioning material layer 211 may have a height less than that of the silicon photonic chip 100. In other words, it is not necessary for the transparent cushioning material layer 211 to span the entire height of the side surface. Instead, it may only span part of the height proximate the top surface 100a. Connecting the port 101 to the fiber optic 600 via the transparent cushioning material layer 211 can dispense with the use of a dedicated optical converter chip for optical conversion, simplifying the structure of the optical device and avoiding noise resulting from a mismatch between an optically conductive material and the fiber optic.

In other embodiments, the silicon photonic chip package module 1 may further include an electronic chip with solder pads, which are, for example, arranged on the same side of the silicon photonic chip package module 1 as the solder pads on the silicon photonic chip.

In other embodiments, the silicon photonic chip may have two or more ports 101. Alternatively, the port may be instead provided on the top surface 100a.

The silicon photonic chip package module 1 further includes a plastic encapsulation layer 200, which fills gaps surrounding the silicon photonic chip 100, for example, gaps between adjacent silicon photonic chips 100. It is configured to fix and electrically isolate the silicon photonic chip 100. The plastic encapsulation layer 200 may be made of a material, examples of which may include, for example, epoxy resins, materials containing 85% to 90% of silica particles and polymer materials. The plastic encapsulation layer 200 has a first surface 200a on the same side of the top surface 100a and a second surface 200b on the same side of the bottom surface 100b. That is, the top surface 100a and the first surface 200a are located on one side of the silicon photonic chip package module 1, and the bottom surface 100b and the second surface 200b are located on the other side of the silicon photonic chip package module 1. The solder pads on the silicon photonic chip 100 are exposed at the first surface 200a. The plastic encapsulation layer 200 has a thickness greater than or equal to that of the silicon photonic chip 100. The plastic encapsulation layer 200 has a groove 210 in its first surface 200a, which extends towards the port 101 and terminates at one end within the transparent cushioning material layer 211. The transparent cushioning material layer 211 can provide protection for the port 101 by avoiding the silicon photonic chip 100 or the port 101 from being undesirably damaged during the formation of the groove 210 in the plastic encapsulation layer 200 by laser etching.

The fiber optic 600 is disposed in the groove 210 and connected to the port 101 of the silicon photonic chip 100 via the transparent cushioning material layer 211. In the embodiment shown in FIG. 3A, the transparent cushioning material layer 211 for connecting the fiber optic 600 to the port 101 has a rectangular cross-section. In the embodiment shown in FIG. 3B, the transparent cushioning material layer 211 is shaped like a frustum of a cone. In this way, it can act as an optical element capable of modifying an optical signal from the fiber optic 600. The larger base of the frustum is coupled to the side surface provided with the port 101, and the smaller base of the frustum is coupled to the fiber optic 600. The frustoconical design allows a spot diameter of an optical signal from the fiber optic 600 to be expanded during its propagation through the transparent cushioning material layer 211 so that, even when there is an alignment error between the end of the fiber optic 600 and the light-receiving port 101 of the silicon photonic chip 100, optical signals can be received, achieving alignment error compensation and lowering requirements for alignment accuracy.

The groove 210 in the plastic encapsulation layer 200 can prevent the fiber optic 600 from protruding beyond the plastic encapsulation layer 200 during subsequent packaging of the silicon photonic chip package module 1 onto another chip or substrate and hence from affecting the packaging quality. The groove 210 may have a width of 10 μm to 1 mm.

The silicon photonic chip package module 1 further includes a plurality of through holes (not shown) in the plastic encapsulation layer 200, which extend through the plastic encapsulation layer in the direction of thickness thereof, and a conductive material is filled in the through holes in order to electrically connect to a circuit on the first surface 200a to a circuit on the second surface 200b. The conductive material may be, for example, a conductive metal, such as copper (Cu), tungsten (W), silver (Ag) or gold (Au), a conductive alloy, or a conductive adhesive.

The silicon photonic chip package module 1 further includes a first passivation layer 310, a metal interconnect layer 400 and a second passivation layer 320, which are sequentially stacked on the top surface 100a. The first passivation layer 310 covers the first surface 200a and the top surface 100a, and the metal interconnect layer 400 covers part of the first passivation layer 310. The second passivation layer 320 covers the metal interconnect layer 400 and the first passivation layer 310. The first passivation layer 310 and the second passivation layer 320 are provided to isolate the metal interconnect layer 400 and prevent the occurrence of a short circuit therein.

Preferably, the first passivation layer 310 and the second passivation layer 320 are both insulating materials, such as polymer materials. Further, each of the insulating materials may be, for example, one or more of polyimide (PI), benzocyclobutene (BCB) and poly(p-phenylene-2,6-benzobisoxazole) (PBO). The first passivation layer 310 and the second passivation layer 320 may be made of the same or different materials. In this embodiment, both the first passivation layer 310 and the second passivation layer 320 are made of PI.

The metal interconnect layer 400 may be a metal material, such as Cu, Ag, W or Au, a conductive alloy, an inorganic material, such as a conductive oxide (e.g., ITO), or a conductive organic material, such as a conductive polymer. The metal interconnect layer 400 may have a thickness of about 3 μm to 10 μm, preferably 3 μm to 5 μm, over the surface of the first passivation layer 310.

A first via hole and a second via hole may be formed in the first passivation layer 310, and a conductive material may be filled in the first and second via holes so as to be electrically connected, at one end, to the metal interconnect layer 400 and, at the other end, to the conductive material filled in the through holes and the solder pads on the silicon photonic chip 100, accomplishing electrical connection of the silicon photonic chip package module I on the first surface 200a. Via holes may also be provided in the second passivation layer 320, and a conductive material may be filled in the via holes to form several solder pads 410, which are connected to the metal interconnect layer 400 at one end and exposed out of the second passivation layer 310 at the other end, allowing the metal interconnect layer 400 to be electrically connected to an external circuit. Moreover, the metal interconnect layer 400 can provide all the functions of metal wires that would be otherwise needed, while taking up less space than the metal wires would occupy, making the product more competitive. Moreover, its resistance is 30% to 50% lower than that of the metal wires, resulting in a significant reduction in loss of electrical energy and an increase in utilization of electrical energy. Further, it reduces the risk of circuit damage resulting from heat dissipation and dispenses with the need of adding a heat sink, resulting in reduced material cost. In other embodiments, the electronic chip may be electrically connected to the silicon photonic chip and an external circuit by the metal interconnect layer.

Solder balls may be formed on the solder pads in order to electrically connect the silicon photonic chip package module 1 to other circuits. The optical device further includes a substrate 2, the metal pad structures 500 are formed on the substrate 2. The silicon photonic chip package module 1 is electrically connected to the metal pad structures 500 in such a manner that the solder balls of the silicon photonic chip package module 1 are electrically connected to the metal pad structures 500 on the substrate 2. As would be appreciated, the use of the spacing-saving, structurally simple silicon photonic chip package module 1 allows simpler internal wiring of the substrate 2 and space savings for the substrate.

As shown in FIG. 5, in this embodiment, the silicon photonic chip 100 has five ports 101, and five grooves 210 are opened on the side of the plastic encapsulation layer 200 to set the fiber optic 600. Each fiber optic 600 is aligned with a corresponding port 101, and the fiber optic 600 is coupled with the port 101 through the transparent cushioning material layer 211. The silicon photonic chip 100 can be electrically connected to another silicon photonic chip 100′, such as an electrical chip, through the metal wires in the metal interconnect layer 400. The metal wires in the metal interconnect layer 400 can also be connected to the solder pads 410 to form an electrical connection with the external circuit through the solder pads 410. The number of ports and the arrangement of metal wires and solder pads on the chip surface shown in FIG. 5 are for illustration purposes only and are not limited by this embodiment.

With continued reference to FIGS. 1 to 5, in an embodiment of the present invention, there is provided a method of packaging an optical device. Here, by “packaging”, it is intended to mean that silicon photonic chips 100 and a substrate 2 are packaged to form the optical device. The method includes the steps as follows:

S1: Provide a carrier substrate provided on one side thereof with an adhesive layer. The carrier substrate may have a circular or square shape, for example.

S2: Place a plurality of silicon photonic chips 100 on the adhesive layer so that they are spaced apart from one another. Top surfaces 100a of the silicon photonic chips 100 face toward the adhesive layer. The silicon photonic chips 100 are oriented in the same direction. Adjacent silicon photonic chips 100 are spaced apart at a distance greater than or equal to 50 μm and less than 100 μm. A port 101 is provided in a side surface of each silicon photonic chip 100 and proximate the top surface 100a thereof, and is covered with a transparent cushioning material layer 211. In case of the transparent cushioning material layer 211 being provided in the form of a frustum of a cone, the transparent cushioning material may be shaped as desired using a nanoimprint technique and then cured by UV radiation. Solder pads 410 for electrical connection with external circuits are provided on the top surfaces 100a of the silicon photonic chips 100.

S3: Fill a plastic encapsulation material between the silicon photonic chips 100 and solidify the plastic encapsulation material to form a plastic encapsulation layer 200 having a first surface 200a and a second surface 200b opposite to the first surface 200a. The first surface 200a of the plastic encapsulation layer and the top surfaces 100a are located on the same side of silicon photonic chip package modules 1 being fabricated. The plastic encapsulation layer 200 has a thickness greater than or equal to a thickness of the silicon photonic chips 100.

S4: Form grooves 210 in the plastic encapsulation layer 200, which extend towards the ports 101 and terminate at one end within the transparent cushioning material layer 211. The grooves 210 have a width of 10 μm to 1 mm, and are configured to receive fiber optics 600 therein. This can prevent the fiber optics 600 from protruding beyond the plastic encapsulation layer 200 during subsequent packaging of the silicon photonic chip package modules 1 onto another chip or substrate and hence from affecting the packaging quality.

S5: Remove the carrier substrate. Specifically, the carrier substrate may be, for example, heated and thereby separated from the plastic encapsulation layer 200 and the silicon photonic chips 100.

S6: Form a plurality of through holes in the plastic encapsulation layer 200, which extend through the plastic encapsulation layer 200 in the direction of thickness thereof, and fill a conductive material in the through holes.

S7: Sequentially form a first passivation layer 310, a metal interconnect layer 400 and a second passivation layer 320 on the first surface 200a and the top surfaces 100a. The metal interconnect layer 400 is configured for electrical connection with the solder pads 410 on the silicon photonic chips 100 and with the conductive material filled in the through holes. First and second via holes may be provided in the first passivation layer 310, and a conductive material may be filled in the first and second via holes so as to be electrically connected, at one end, to the metal interconnect layer 400, and, at the other end, to the conductive material filled in the through holes and the solder pads 410 on the silicon photonic chips 100, accomplishing electrical connection of the silicon photonic chip package module 1 on the first surface 200a. Via holes may be provided in the second passivation layer 320, and a conductive material may be filled in the via holes to form several solder pads 410, which are connected to the metal interconnect layer 400 at one end and exposed out of the second passivation layer 310 at the other end, allowing the metal interconnect layer 400 to be electrically connected to an external circuit. As a result, the silicon photonic chip package modules 1 are formed.

S8: Separate the silicon photonic chip package modules 1, each of which includes at least one of the silicon photonic chips 100.

S9: Provide a substrate 2 with metal pad structures 500 formed thereon.

S10: Packaging the silicon photonic chip package modules 1 onto the substrate 2 using a ball array packaging (BGA) technique, thereby forming an optical device. The metal pad structures 500 are electrically connected to the solder pads 410.

Specifically, a conductive material, such as a solder or low-temperature sintered material, may be coated on the metal pad structures 500, and the silicon photonic chip package modules I may be then placed on the substrate 2 so that the solder pads 410 on the silicon photonic chip package modules 1 are aligned with the metal pad structures 500. Finally, the solder pads 410 may be adhesively bonded to the metal pad structures 500, thereby connecting the silicon photonic chip package modules 1 to the substrate 2.

It is to be understood that while the invention has been described above with reference to preferred embodiments thereof, it is not limited to these embodiments. In light of the above teachings, any person familiar with the art may make many possible modifications and variations to the disclosed embodiments or adapt them into equivalent arrangements, without departing from the scope of the invention. Accordingly, it is intended that any and all simple variations, equivalent changes and modifications made to the foregoing embodiments based on the substantive disclosure of the invention without departing from the scope thereof fall within this scope.

1. A silicon photonic chip package module, comprising:
a silicon photonic chip having a top surface, a bottom surface and side surfaces and incorporating an optical signal processing element, wherein a port connected to the optical signal processing element is provided on one of the side surfaces;
a transparent cushioning material layer provided on said side surface of the silicon photonic chip so as to cover the port; and
a plastic encapsulation layer, which at least surrounds the side surfaces of the silicon photonic chip and thus at least circumferentially encapsulates the silicon photonic chip,
wherein a groove for receiving a fiber optic therein is provided in the plastic encapsulation layer, the groove extending towards the port and one end of the groove terminating within the transparent cushioning material layer, thereby allowing the port to be optically connected to the fiber optic through the transparent cushioning material layer and to receive an optical signal.

2. The silicon photonic chip package module of claim 1, wherein the transparent cushioning material layer has a light transmittance of 95% or higher.

3. The silicon photonic chip package module of claim 1, wherein the transparent cushioning material layer has a thickness of 50-100 μm in a direction of propagation of an optical signal therein.

4. The silicon photonic chip package module of claim 1, wherein the transparent cushioning material layer has a height less than a height of the silicon photonic chip.

5. The silicon photonic chip package module of claim 1, wherein the transparent cushioning material layer is configured as an optical element for modifying an optical signal from the fiber optic.

6. The silicon photonic chip package module of claim 5, wherein the transparent cushioning material layer is configured as an optical element in the form of a frustum of a cone, the frustum having a large base coupled to the side surface with the port provided therein, the frustum having a smaller base configured to be coupled to the fiber optic.

7. The silicon photonic chip package module of claim 1, wherein:
solder pads are provided on the top surface of the silicon photonic chip;
the plastic encapsulation layer comprises: a first surface located on the same side of the silicon photonic chip package module as the top surface of the first surface and the silicon photonic chip; and a plurality of through holes, which extend through the plastic encapsulation layer in a direction of a thickness of the plastic encapsulation layer; and
the silicon photonic chip package module further comprises a metal interconnect layer, which covers the first surface and part of the top surface and is electrically connected to the solder pads.

8. The silicon photonic chip package module of claim 1, further comprising first and second passivation layers for isolating the metal interconnect layer, the first passivation layer covering the first surface and the top surface and partially covered by the metal interconnect layer, the second passivation layer covering the metal interconnect layer and the first passivation layer.

9. The silicon photonic chip package module of claim 8, wherein first and second via holes are provided in the first passivation layer, and a conductive material is filled in the first and second via holes, one end of the conductive material filled in the first and second via holes electrically connected to the metal interconnect layer, the other end of the conductive material filled in the first and second via holes electrically connected to the conductive material filled in the through holes and the solder pads on the silicon photonic chip, thereby accomplishing electrical connection of the silicon photonic chip package module on the first surface, and wherein via holes are provided in the second passivation layer, and a conductive material is filled in the via holes to form a number of solder pads, one end of the solder pads are connected to the metal interconnect layer and the other end of the solder pads are exposed by the second passivation layer, thereby allowing the metal interconnect layer to be connected to an external circuit.

10. A silicon photonic chip package module, comprising:
a plurality of mutually spaced silicon photonic chips, each having a top surface, a bottom surface and side surfaces and incorporating an optical signal processing element, wherein a port connected to the optical signal processing element is provided on one of the side surfaces;
transparent cushioning material layers, which are provided on said side surfaces of the respective silicon photonic chip so as to cover the respective ports; and
a plastic encapsulation layer, which is filled in gaps around each silicon photonic chip to electrically isolate these silicon photonic chips,
wherein grooves for receiving fiber optics therein are provided in the plastic encapsulation layer, each of the grooves extending towards the port of a respective one of the silicon photonic chips and one end of each groove terminating within a respective one of the transparent cushioning material layers, thereby allowing the ports of the respective silicon photonic chips to be optically connected to the respective fiber optics through the respective transparent cushioning material layers and to receive optical signals.

11. The silicon photonic chip package module of claim 10, wherein adjacent silicon photonic chips are spaced at a distance greater than or equal to 50 μm and less than 100 μm.

12. The silicon photonic chip package module of claim 10, wherein each groove has a width of 10 μm to 1 mm.

13. The silicon photonic chip package module of claim 10, wherein each transparent cushioning material layer has a light transmittance of 95% or higher.

14. The silicon photonic chip package module of claim 10, wherein each transparent cushioning material layer has a thickness of 50-100 μm in a direction of propagation of an optical signal therein.

15. The silicon photonic chip package module of claim 10, wherein the transparent cushioning material layers have a height less than a height of the silicon photonic chips.

16. The silicon photonic chip package module of claim 10, wherein each transparent cushioning material layer is configured as an optical element for modifying an optical signal from a respective one of the fiber optics.

17. The silicon photonic chip package module of claim 16, wherein each transparent cushioning material layer is configured as an optical element in the form of a frustum of a cone, the frustum having a large base coupled to the side surface with the port provided therein, the frustum having a smaller base configured to be coupled to the respective fiber optic.
